(19) United States
(12) Patent Application Publication
(10) Pub. No.: US 2025/0013785 A1
(43) Pub. Date: Jan. 9, 2025

(54) Creative Micro-Community System

(71) Applicant: Bank of America Corporation, Charlotte, NC (US)

(72) Inventors: Shola L. Oni, Atlanta, GA (US); Christine D. Black, Brooksville, ME (US); Victoria L. Dravneek, CHARLOTTE, NC (US); Katherine Dintenfass, Lincoln, RI (US); Monika Kapur, Jacksonville, FL (US); Jinna Kim, Charlotte, NC (US); Jo-Ann Taylor, Godalming, Surrey (GB); Vijaya L. Vemireddy, Plano, TX (US)

(73) Assignee: Bank of America Corporation, Charlotte, NC (US)

(21) Appl. No.: 18/218,808

(22) Filed: Jul. 6, 2023

(51) Int. Cl. G06F 21/62; G06F 11/34

(52) U.S. Cl. CPC G06F 21/6254; G06F 11/3438

(57) ABSTRACT

A computing platform to form creative micro-communities of users aggregates electronic data records about electronic activities performed via one or more application computing systems providing products or services to users. An artificial intelligence/machine learning (AI/ML) model is continually trained to identify users with similar interests and group users into micro-communities based on the identified common interests. The computing platform generates micro-communities based on AI determined features or identifiers of a user, or a user may self-identify in a particular category to join the micro-community. Each micro-community may have tiers of participants that may be identified via the AI/ML models. Each micro-community may have customized rules, parameters, or the like, such as protections from certain types of communications.

### BACKGROUND

Large organizations, such as financial institutions and other large enterprise organizations, may provide many different products and/or services. To support these complex and large-scale operations, a large organization may own, operate, and/or maintain many different computer systems that service different internal users and/or external users in connection with different products and services. In addition, some computer systems internal to the organization may be configured to exchange information with computer systems external to the organization so as to provide and/or support different products and services offered by the organization. In providing services, these organizations may maintain one or more data repositories of information relating to the various services, and/or users of the various services, that may be offered by the organizations. In some cases, a user of the services provided by the organization may have specialized expertise, interests, and/or skills and may desire input from peers that may also be users of products and/or services provided via the organization's network. However, using current mechanisms, the reliability of the input received from other users may not be known. As such, a need has been recognized to provide a secure network in which a micro-community may be established.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary presents some concepts of the disclosure in a simplified form as a prelude to the description below.

Aspects of the disclosure relate to computer systems that provide effective, efficient, scalable, and convenient ways of securely and uniformly managing how internal computer systems exchange information with external computer systems to provide and/or support different products and services offered by an organization (e.g., a financial institution, and the like).

Aspects of the disclosure relate to computer hardware and software. In particular, one or more aspects of the disclosure generally relate to computer hardware and software for processing electronic data records to identify patterns of activity via, for example, a machine learning model to organically form creative micro-communities based on electronic activities of users of products and services of an enterprise network and managing the micro-communities once formed.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The enterprise organization may mine electronic data records from electronic activities performed via one or more application computing systems providing products or services to users. An artificial intelligence/machine learning (AI/ML) model may be continually trained to identify people with similar interests and create micro-communities based on the identified common interests. Users may provide information about interests, talents, business focus, or the like, and/or information may be obtained from internal and/or external data. The system can connect people with similar interests (e.g., as identified using ML/AI, data analysis, etc.) or people who could benefit from being connected (e.g., a philanthropist, a grant writer, etc.). The AI/ML model may identify or anticipate a user's needs (e.g., financial needs) and connect users with other users who may be able to assist, and/or trigger application computing systems to communicate targeted recommendations for certain products or services. In some examples, the AI/ML model may connect creative people with business-focused people who can help launch a business and/or may trigger communication of offers that provide options for benefits that may be targeted to particular users' passions, assist with crowd-sourced funding, and the like. The micro-communities may be generated based on AI determined features or identifiers or a user, or a user may self-identify in a particular category to join the micro-community. In some examples, users may be vetted before being given access to the micro-community, or may have limited access until vetted. In some cases, each community may have tiers of participants that may be identified via the AI/ML models. Tiers may be based on time in creative area, activity on social media, experience or reputation scores calculated from their activities or experience, and/or the like. Each micro-community may have customized rules, parameters, or the like, such as protections from certain types of communications. In some examples, fraud protections may be implemented within the micro-communities to protect users. The micro-communities may curate partnerships with the enterprise organization or other entities, may automatically monitor and moderate user interactions, and may have moderators. The micro-communities could provide a trusted consortium of sources, data, and the like. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1A shows an illustrative computing environment for identification and management of micro-communities, in accordance with one or more aspects described herein;

FIG. 1B shows an illustrative computing platform enabled for identification and management of micro-communities, in accordance with one or more aspects described herein;

FIG. 2 shows an illustrative method for identifying and managing micro-communities in accordance with one or more aspects described herein; and

FIG. 3 shows an illustrative computing environment including an organization computing system configured to identify and manage micro-communities of users in accordance with one or more aspects described herein

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As used throughout this disclosure, computer-executable “software and data” can include one or more: algorithms, applications, application program interfaces (APIs), attachments, big data, daemons, emails, encryptions, databases, datasets, drivers, data structures, file systems or distributed file systems, firmware, graphical user interfaces, images, instructions, machine learning (e.g., supervised, semi-supervised, reinforcement, and unsupervised), middleware, modules, objects, operating systems, processes, protocols, programs, scripts, tools, and utilities. The computer-executable software and data is on tangible, computer-readable memory (local, in network-attached storage, or remote), can be stored in volatile or non-volatile memory, and can operate autonomously, on-demand, on a schedule, and/or spontaneously.

“Computer machines” can include one or more: general-purpose or special-purpose network-accessible administrative computers, clusters, computing devices, computing platforms, desktop computers, distributed systems, enterprise computers, laptop or notebook computers, primary node computers, nodes, personal computers, portable electronic devices, servers, node computers, smart devices, tablets, and/or workstations, which have one or more microprocessors or executors for executing or accessing the computer-executable software and data. References to computer machines and names of devices within this definition are used interchangeably in this specification and are not considered limiting or exclusive to only a specific type of device. Instead, references in this disclosure to computer machines and the like are to be interpreted broadly as understood by skilled artisans. Further, as used in this specification, computer machines also include all hardware and components typically contained therein such as, for example, processors, executors, cores, volatile and non-volatile memories, communication interfaces, etc.

Computer “networks” can include one or more local area networks (LANs), wide area networks (WANs), the Internet, wireless networks, digital subscriber line (DSL) networks, frame relay networks, asynchronous transfer mode (ATM) networks, virtual private networks (VPN), or any combination of the same. Networks also include associated “network equipment” such as access points, ethernet adaptors (physical and wireless), firewalls, hubs, modems, routers, and/or switches located inside the network and/or on its periphery, and software executing on the foregoing.

The above-described examples and arrangements are merely some examples of arrangements in which the systems described herein may be used. Various other arrangements employing aspects described herein may be used without departing from the innovative concepts described.

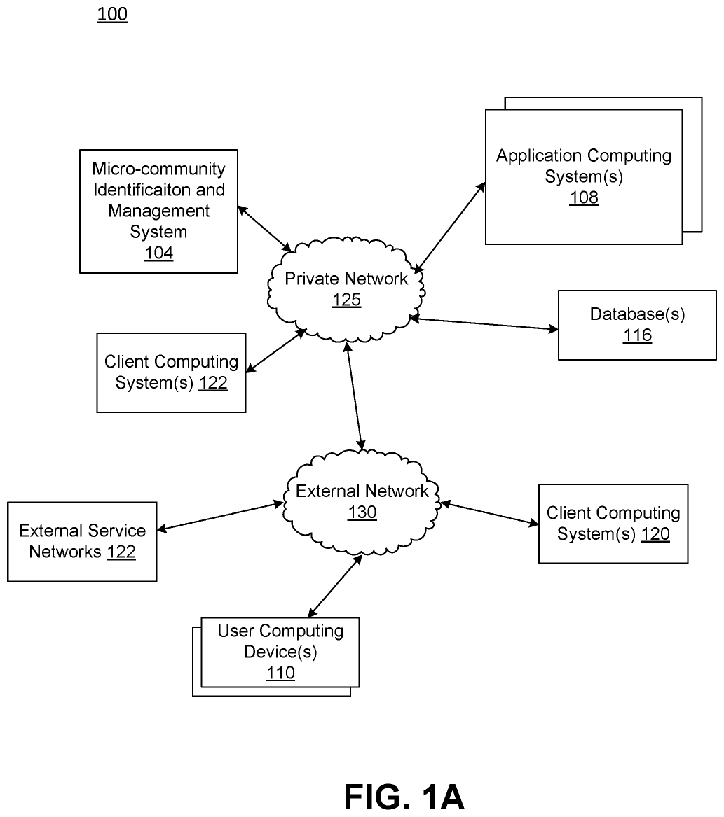

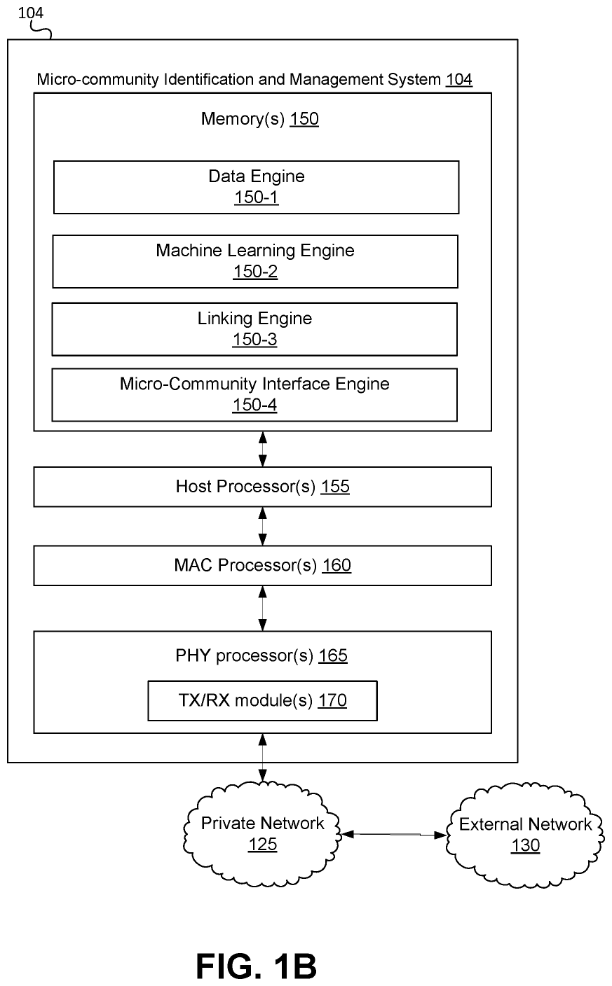

The enterprise organization may mine electronic data records from electronic activities performed via one or more application computing systems providing products or services to users. An artificial intelligence/machine learning (AI/ML) model may be continually trained to identify people with similar interests and create micro-communities based on the identified common interests. Users may provide information about interests, talents, business focus, or the like, and/or information may be obtained from internal and/or external data. The system can connect people with similar interests (e.g., as identified using ML/AI, data analysis, etc.) or people who could benefit from being connected (e.g., a philanthropist, a grant writer, etc.). The AI/ML model may identify or anticipate a user's needs (e.g., financial needs) and connect users with other users who may be able to assist, and/or trigger application computing systems to communicate targeted recommendations for certain products or services. In some examples, the AI/ML model may connect creative people with business-focused people who can help launch a business and/or may trigger communication of offers that provide options for benefits that may be targeted to particular users' passions, assist with crowd-sourced funding, and the like. The micro-communities may be generated based on AI determined features or identifiers or a user, or a user may self-identify in a particular category to join the micro-community. In some examples, users may be vetted before being given access to the micro-community, or may have limited access until vetted. In some cases, each community may have tiers of participants that may be identified via the AI/ML models. Tiers may be based on time in creative area, activity on social media, experience or reputation scores calculated from their activities or experience, and/or the like. Each micro-community may have customized rules, parameters, or the like, such as protections from certain types of communications. In some examples, fraud protections may be implemented within the micro-communities to protect users. The micro-communities may curate partnerships with the enterprise organization or other entities, may automatically monitor and moderate user interactions, and may have moderators. The micro-communities could provide a trusted consortium of sources, data, and the like. FIG. 1A shows an illustrative computing environment 100 for identification and management of micro-community, in accordance with one or more arrangements. The computing environment 100 may comprise one or more devices (e.g., computer systems, communication devices, and the like). The computing environment 100 may comprise, for example, a micro-community identification management system 104, one or more application system 108, and/or one or more database(s) 116. The one or more of the devices and/or systems, may be linked over a private network 125 associated with an enterprise organization (e.g., a financial institution, a business organization, an educational institution, a governmental organization and the like). The computing environment 100 may additionally comprise a client computing system 120 and one or more user devices 110 connected, via a public network 130, to the devices in the private network 125. The devices in the computing environment 100 may transmit/exchange/share information via hardware and/or software interfaces using one or more communication protocols. The communication protocols may be any wired communication protocol(s), wireless communication protocol(s), one or more protocols corresponding to one or more layers in the Open Systems Interconnection (OSI) model (e.g., local area network (LAN) protocol, an Institution of Electrical and Electronics Engineers (IEEE) 802.11 WIFI protocol, a 3rd Generation Partnership Project (3GPP) cellular protocol, a hypertext transfer protocol (HTTP), etc.). While FIG. 1A shows the micro-community identification management system 104 as a separate computing system, but may be incorporated within multiple computing systems.

The micro-community identification management system 104 may comprise one or more computing devices and/or other computer components (e.g., processors, memories, communication interfaces) configured to perform one or more functions as described herein. Further details associated with the architecture of the micro-community identification management system 104, are described with reference to FIG. 1B.

The application systems 108 and/or external service networks 122 may comprise one or more computing devices and/or other computer components (e.g., processors, memories, communication interfaces). In addition, the a application systems 108 and/or the external service networks 122 may be configured to host, execute, and/or otherwise provide one or more enterprise applications. In some cases, the application systems 108 and/or the external service networks 122 may host one or more services configured facilitate operations requested through one or more API calls, such as data retrieval and/or initiating processing of specified functionality. In some cases, the external service networks 122 may be configured to communicate with one or more of the application computing systems 108 such as via direct communications and/or API function calls and the services. In an arrangement where the private network 125 is associated with a financial institution (e.g., a bank), the application computing systems 108 may be configured, for example, to host, execute, and/or otherwise provide one or more transaction processing programs, such as an online banking application, fund transfer applications, and/or other programs associated with the financial institution. The application systems 108 and/or the external service networks 122 may comprise various servers and/or databases that store and/or otherwise maintain account information, such as financial account information including account balances, transaction history, account owner information, and/or other information. In addition, application systems 108 and/or the external service networks 122 may process and/or otherwise execute transactions on specific accounts based on commands and/or other information received from other computer systems comprising the computing environment 100. In some cases, one or more of application systems 108 and/or the external service networks 122 may be configured, for example, to host, execute, and/or otherwise provide one or more transaction processing programs, such as electronic fund transfer applications, online loan processing applications, and/or other programs associated with the financial institution. Additionally, or alternatively, the external service networks 122 may include one or more public or private service networks accessible to users via their user computing devices 110 via the external network 130. Such external service networks 122 may include one or more social networks, bulletin boards, specialty online communities that may align with one or more interests of the users, including, but not limited to, creative activities (e.g., art appreciation, art creation, painting, musical appreciation, musical performance, creative writing, literary writing, sculpting, sporting activities, and the like). Such external service networks 122 may allow users to interact with other individuals sharing same or similar interests, wherein the individuals may have the same or different levels of expertise. Being online public communities, often users cannot rely upon advice of other individuals since the veracity or accuracy of advice, opinions, and the like cannot be verified easily.

The application computing systems 108 may be one or more host devices (e.g., a workstation, a server, and the like) or mobile computing devices (e.g., smartphone, tablet). In addition, an application computing systems 108 may be linked to and/or operated by a specific enterprise user (who may, for example, be an employee or other affiliate of the enterprise organization) who may have administrative privileges to perform various operations within the private network 125. In some cases, the application computing system 108 may be capable of performing one or more layers of user identification based on one or more different user verification technologies including, but not limited to, password protection, pass phrase identification, biometric identification, voice recognition, facial recognition and/or the like. In some cases, a first level of user identification may be used, for example, for logging into an application or a web server and a second level of user identification may be used to enable certain activities and/or activate certain access rights.

The client computing system 120 may comprise one or more computing devices and/or other computer components (e.g., processors, memories, communication interfaces). The client computing system 120 may be configured, for example, to host, execute, and/or otherwise provide one or more transaction processing programs, such as goods ordering applications, electronic fund transfer applications, online loan processing applications, and/or other programs associated with providing a product or service to a user. With reference to the example where the client computing system 120 is for processing an electronic exchange of goods and/or services. The client computing system 120 may be associated with a specific goods purchasing activity, such as purchasing a vehicle, transferring title of real estate may perform communicate with one or more other platforms within the client computing system 120. In some cases, the client computing system 120 may integrate API calls to request data, initiate functionality, or otherwise communicate with the one or more application computing systems 108, such as via the services. For example, the services may be configured to facilitate data communications (e.g., data gathering functions, data writing functions, and the like) between the client computing system 120 and the one or more application computing systems 108.

The user device(s) 110 may be computing devices (e.g., desktop computers, laptop computers) or mobile computing device (e.g., smartphones, tablets) connected to the network 125. The user device(s) 110 may be configured to enable the user to access the various functionalities provided by the devices, applications, and/or systems in the network 125.

The database(s) 116 may comprise one or more computer-readable memories storing information that may be used by the micro-community identification management system 104. For example, the database(s) 116 may store micro-community associations, activity identification information, skill level information, expertise information, creative activity information, and the like. In an arrangement, the database(s) 116 may be used for other purposes as described herein. In some cases, the client computing system 120 may write data or read data to the database(s) 116 via the services.

In one or more arrangements, the micro-community identification management system 104, the application computing systems 108, the client computing system 120, the external service networks 122, the user devices 110, and/or the other devices/systems in the computing environment 100 may be any type of computing device capable of receiving input via a user interface, and communicating the received input to one or more other computing devices in the computing environment 100. For example, the micro-community identification management system 104, the application computing systems 108, the client computing system 120, the external service networks 122, the user devices 110, and/or the other devices/systems in the computing environment 100 may, in some instances, be and/or include server computers, desktop computers, laptop computers, tablet computers, smart phones, wearable devices, or the like that may comprised of one or more processors, memories, communication interfaces, storage devices, and/or other components. Any and/or all of the micro-community identification management system 104, the application computing systems 108, the client computing system 120, the external service networks 122, the user devices 110, and/or the other devices/systems in the computing environment 100 may, in some instances, be and/or comprise special-purpose computing devices configured to perform specific functions.

FIG. 1B shows an illustrative micro-community identification management system 104 in accordance with one or more examples described herein. The micro-community identification management system 104 may be a stand-alone device and/or may at least be partial integrated with the development computing system 104 may comprise one or more of host processor(s) 155, medium access control (MAC) processor(s) 160, physical layer (PHY) processor(s) 165, transmit/receive (TX/RX) module(s) 170, memory 150, and/or the like. One or more data buses may interconnect host processor(s) 155, MAC processor(s) 160, PHY processor(s) 165, and/or Tx/Rx module(s) 170, and/or memory 150. The micro-community identification management system 104 may be implemented using one or more integrated circuits (ICs), software, or a combination thereof, configured to operate as discussed below. The host processor(s) 155, the MAC processor(s) 160, and the PHY processor(s) 165 may be implemented, at least partially, on a single IC or multiple ICs. The memory 150 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 160 and/or the PHY processor(s) 165 of the micro-community identification management system 104 may be configured to generate data units, and process received data units, that conform to any suitable wired and/or wireless communication protocol. For example, the MAC processor(s) 160 may be configured to implement MAC layer functions, and the PHY processor(s) 165 may be configured to implement PHY layer functions corresponding to the communication protocol. The MAC processor(s) 160 may, for example, generate MAC data units (e.g., MAC protocol data units (MPDUs)), and forward the MAC data units to the PHY processor(s) 165. The PHY processor(s) 165 may, for example, generate PHY data units (e.g., PHY protocol data units (PPDUs)) based on the MAC data units. The generated PHY data units may be transmitted via the TX/RX module(s) 170 over the private network 125. Similarly, the PHY processor(s) 165 may receive PHY data units from the TX/RX module(s) 165, extract MAC data units encapsulated within the PHY data units, and forward the extracted MAC data units to the MAC processor(s). The MAC processor(s) 160 may then process the MAC data units as forwarded by the PHY processor(s) 165.

One or more processors (e.g., the host processor(s) 155, the MAC processor(s) 160, the PHY processor(s) 165, and/or the like) of the micro-community identification management system 104 may be configured to execute machine readable instructions stored in memory 150. The memory 150 may comprise (i) one or more program modules/engines having instructions that when executed by the one or more processors cause the micro-community identification management system 104 to perform one or more functions described herein and/or (ii) one or more databases that may store and/or otherwise maintain information which may be used by the one or more program modules/engines and/or the one or more processors. The one or more program modules/engines and/or databases may be stored by and/or maintained in different memory units of the micro-community identification management system 104 and/or by different computing devices that may form and/or otherwise make up the micro-community identification management system 104. For example, the memory 150 may have, store, and/or comprise a data engine 150-1, a machine learning engine 150-2, a linking engine 150-3, a micro-community interface engine 150-4, and/or the like. The data engine 150-1 may have instructions that direct and/or cause the micro-community identification management system 104 to perform one or more operations associated with aggregating and grouping data from a plurality of sources including the application computing systems 108, the databases 116, the external service networks 122, and the like. The machine learning engine 150-2 may have instructions that may cause the micro-community identification management system 104 to automatically train and manage machine learning or other artificial intelligence models to analyze data aggregated and/or processed by the data engine 150-1, where the models may identify micro-communities that may be formed, identify members of appropriate experience that may be automatically invited to be part of one or more of the micro-communities, and retrain the models based on feedback received via user interface queries and/or analysis of operations performed by members of the micro-communities. The linking engine 150-3 may have instructions that may cause the to link users invited to join and have accepted invitations to join micro-communities, and may link the micro-community identification management system 104 and/or one or more application computing systems to certain micro-communities based on actions and/or other activity performed by members of the micro-communities. The micro-community interface engine 150-4 may have instructions that may cause the micro-community identification management system 104 to manage operation of each micro-community, automatically administer interactions between micro-community members, and facilitate user interactions on one or more micro-communities, such as via an application installed on a user device.

While FIG. 1A illustrates micro-community identification management system 104 and/or the application computing systems 108, as being separate elements connected in the private network 125, in one or more other arrangements, functions of one or more of the above may be integrated in a single device/network of devices. For example, elements in micro-community identification management system 104 (e.g., host processor(s) 155, memory(s) 150, MAC processor(s) 160, PHY processor(s) 165, TX/RX module(s) 170, and/or one or more program/modules stored in memory(s) 150) may share hardware and software elements with and corresponding to, for example, the application computing systems 108.

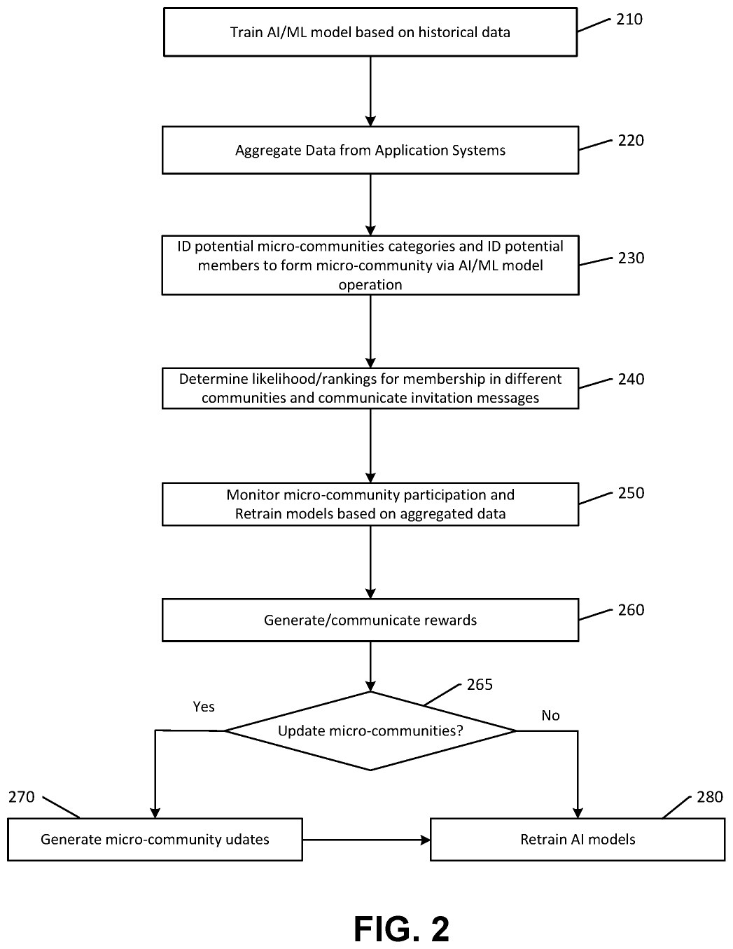

FIG. 2 shows an illustrative method for identifying and managing micro-communities in accordance with one or more aspects described herein. At 210, the machine learning engine 150-2 may train one or more AI/ML models based on historical data to identify one or more micro-communities that may be formed between users of products and/or services provided by the enterprise network. In some cases, the micro-communities may be identified based on actions each user performs such if their activities are performed as a profession, an avocation, a hobby, or the like. Additionally, the model may analyze the activities to determine an experience that each user has for each creative interest, such as to identify whether the user is proficient (e.g., an expert), is learning, or somewhere in between. In some cases, the historical data may be previously aggregated by the data engine 150-1 from one or more data sources, such as the databases 116, the application computing systems 108, and/or one or more of the external service networks 122.

At 220, the data engine may aggregate data in real time or periodically (e.g., hourly, daily, weekly, and the like) from each of the different data sources. For example, the data may include anonymized user transaction information that may identify a creative activity (e.g., an art activity, a musical activity, a sporting activity, and the like). For example, the activities may include electronic data records formed, at least in part, from electronic transaction information that identifies a classification of a vendor (e.g., an art supply store, a photography store, a musical instrument store, a sporting equipment store, and the like), a venue (e.g., an entertainment venue for musical performance, an art gallery, an art museum, a sporting venue, and the like), a support organization (e.g., a foundation, a governmental organization, a writing organization, and the like). Such information may be mined from electronic transactions as payments to or from the user to the various organizations that may be the counter-party to the transaction. Additionally, the data engine 150-1 may mine external service networks (e.g., bulletin boards, social media networks, and the like) for posts associated with the users of the enterprise network that may indicate creative and/or sporting interests of the user, such as to identify posts associated with different user activities that may be associated with creative micro-communities.

At 230, the machine learning engine 150-2 may utilize the trained AI/ML models to identify users that may be interested in joining one or more identified creative micro-communities, based on aggregated data from the data engine 150-1. For example, the AI/ML models may be used to identify creative micro-communities based on a number of different factors including, but not limited to, common experience levels, different experience levels (e.g., a mentoring community), activity types, whether the activities are performed as a profession, as a hobby, as new practitioners, and the like. In some cases, the AI/ML models may identify micro-communities on a local basis, a regional basis, a national basis, or international basis. For example, the AI/ML model may be trained to identify different micro-communities based on patterns of activities performed by the user that may indicate whether the user would like to begin a business based on the creative activity (e.g., become a professional writer or musician, and the like), obtain funding (e.g., obtain grants for creating public works of art, or composition of musical pieces, and the like), or whether mentorship is desired. In some cases, the AI/ML model may base recommendations and other communications based on terms commonly used in each creative activity. Accordingly, the AI/ML model may leverage social media data and in-house data to identify passions, interests, and the like for users, based on the stored electronic data records. The AI/ML model may also formulate communications based on identified language preferences for one or more users and modify communications to “speak their language.” For instance, if the AI/ML model identifies language used by a user is a musician, communications to a micro-community and/or users that may be associated with the micro-community recommendations in language commonly used in that milieu. For example, the system may communicate a recommendation for saving, spending, products, and the like may be in the context of “gigs” or “contracts” rather than a “job” or a “role.” In some examples, automatic communication bots may be modified to communicate with users in terminology associated with each user's “passion,” such as via an application installed on a user device.

At 240, the micro-community identification management system 104 may determine a likelihood scores that a user may join each micro-community and/or may generate rankings that indicate an experience that may influence the user for membership in different communities. Based on these rankings, likelihood scores, or other probabilities, the micro-community identification management system 104 may generate a micro-community membership list and communicate invitation messages to corresponding user devices, such as via an application running on each user device.

At 250, the micro-community identification management system 104 may monitor micro-community participation in each micro-community, where the AI/ML model may analyze the communications and/or activity between micro-community members (with or without feedback from the users) and use this information to continually improve and retrain the AI/ML models to ensure optimum groupings of users. In some cases, the analysis and retraining may be performed on a periodic basis. In some cases, the analysis and retraining may be performed in real time. Based on participation scores assigned to each user in the micro-community, rewards (e.g., points, stars, monetary rewards, discounts, or other activity-specific incentives) may be generated and communicated to each user at 260. In some cases, the rewards may be based on a quality of content (e.g., advice, support, and the like), an amount of participation within the group that provides benefit to other micro-community members, and the like. At 265, the micro-community identification management system 104 may periodically or continually determine to update the micro-community network such as by reconfiguring current micro-community groupings of users, removing micro-communities, or creating new micro-communities based on newly identified interests or otherwise changed interests of the collective users. If the micro-communities are to be updated at 265, then the micro-community identification management system 104 will generate micro-community updates and push the updates to users associated with one or more updated micro-communities and the AI/ML model may be retrained at 280. If no updates are determined at 265, the AI/ML model may be retrained at 280.

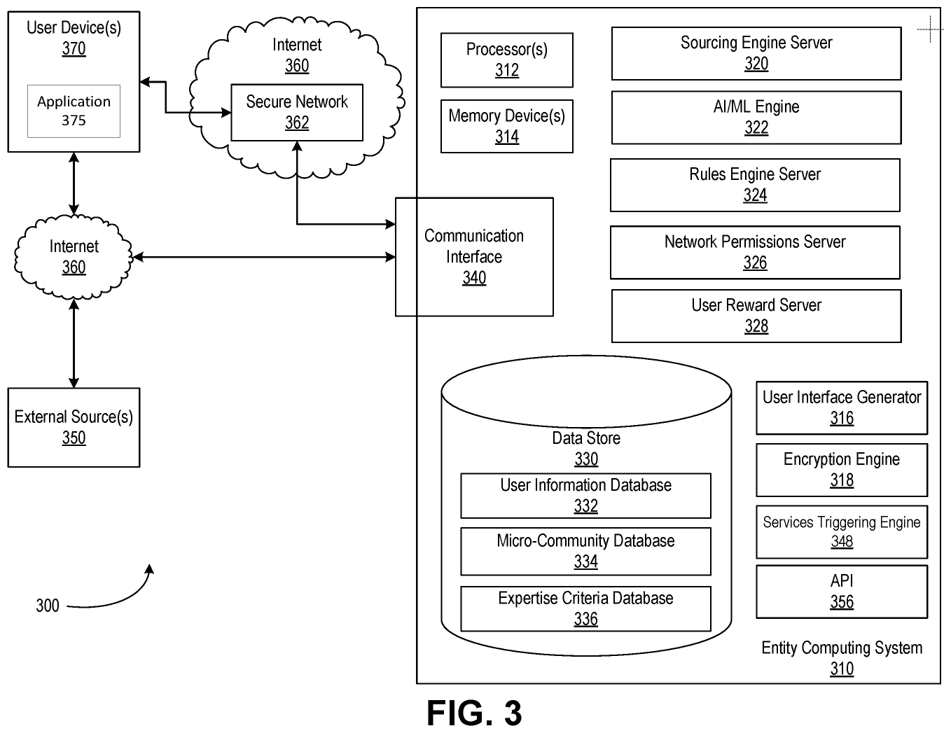

FIG. 3 shows an illustrative computing environment including a networked computing system 300 configured to provide a secure communication network for identification and management of micro-communities of network users. The networked computing system 300 may include one or more computing devices that may include one or more processors 312 and/or memory devices 314. In an illustrative example, the networked computing system 300 may include an entity computing system 310, which may be configured to communicate with one or more user devices 370 and/or one or more external sources 350 (e.g., external computing networks) via a communication network (e.g., the Internet 360). The entity computing system 310 may include one or more servers or other computing devices configured to provide computing functions to facilitate a user experience with products and/or services offered by the entity and/or communication functionality in relation to the products and services. For example, the entity computing system 310 may include a sourcing engine server 320, an Artificial Intelligence/Machine Learning (AI/ML) engine 322, a rules engine server 324, a network permissions server 326, a user reward server 328, a services triggering engine 348, and/or the like. In some cases, one or more servers of the entity computing system 310 may include a user interface generator 316 (e.g. a user interface generation device), an encryption engine to facilitate user communication via a secure network 362 provided by and/or maintained by the various devices of the entity computing system 310. In many cases, one or more devices of the communication interface 340 (e.g., modems, routers, switches, and the like) may be included in the entity computing system 310 as stand-alone devices or included as services incorporated into devices providing other services. The entity computing system 310 may analyze the user-related data stored in the data store 330 using rules stored in or processed by the rules engine server 324. For example, the entity computing system 310 may utilize rules engine server 324 to determine whether data stored the data store 330 corresponds to a micro-community identification data value and/or whether one or more data elements stored in the data store 330 are indicative of a predefined event that may be associated with activities corresponding to one or more micro-communities. If a predefined activity, electronic operation (e.g., an electronic transaction, and the like) is detected, the services triggering engine 348 may send a set of operations to be completed to a user or generate instructions to be executed by one or more different servers. In some cases, predefined events detected by the entity computing system 310 may further be accessed by a multi-platform API 356.

A system may include at least one server having a processor and a communication interface communicatively coupled to an Internet connection and a non-transitory memory device storing instructions that cause the system to retrieve, from a data repository, user information corresponding to a user of products and/or services of a business entity, identify by, at least one a social network identification of the user, and match the user to a plurality of individuals based on the user information. The system may monitor a plurality of social network communications associated with the social network identification of the user using rules provided by the rules engine server 324, and generate, by the sourcing engine server, based on the analyzed social network communications, a trigger condition based on predetermined criteria stored in a database and in response to the trigger condition, solicit, via a secure network, input from the matched individuals corresponding to the trigger condition.

The user devices 370 may be any type of computing device configured to provide the functionality described herein. For instance, the user devices 370 may include a desktop computer, server computer, laptop computer, tablet computer, smartphone, wearable device, automated teller machine (ATM), or the like. In some cases, the user devices 370 may be configured to receive and/or display a user interface, receive input via the user interface, and communicate the received input to one or more other computing devices via a communication network (e.g., the Internet 360, a telecommunications network, a local area network (LAN), a wide area network (WAN), the secure network 362, and the like). As such, the user devices 370 may provide a user interface (e.g., a web browser, a desktop application, a mobile application, or the like) that enables the user to communicate via the Internet 360 to one or more external sources 350, receive notification of individuals for inclusion in one or more micro-communities, and/or communicate to one or more individuals of the micro-community in response to an identified electronic data record associated with a topic associated with one or more micro-communities, trigger one or more actions via the secure network 362. The user devices 370 may, in some instances, be a special-purpose computing device configured to perform specific functions.

The entity computing system 310 may acquire information (e.g., electronic data records) related to social media posts corresponding to the user, the user device 370 associated with the user and/or access notification information, or the user actions associated with a customer of the entity's services and/or products. In some cases, the entity computing system 310 may acquire an access notification information from one or more internal systems, such as systems associated with and/or operated by the organization, corresponding to a product or service provided by the entity. In some examples, the internal systems may include organization servers. The organization servers may be any type of computing device configured to provide the functionality described herein. For instance, an organization server may be a database server, a file server, a web server, an application server, or the like. In some examples, the organization server may include one or more of the sourcing engine server 320, the AI/ML engine 322, the rules engine server 323, the network permissions server 326, the user reward server 328, a server providing the data store 330 (e.g., the user information database 332, the micro-community database 334, the expertise criteria database, a rules database, the and/or the like and may be configured to communicate with the one or more other devices internal or external to the entity computing system 310 relating to information stored on the organization server. The organization server may store, for example, information (e.g., electronic data records) relating to actions corresponding to or otherwise associated with one or more services offered by the organization, one or more applications by the organization, and/or one or more users associated with the organization.

Further, the entity computing system 310, such as by the sourcing engine server 320, may acquire information related to the user, the user devices 370 associated with the user and/or access notification, and/or the user associated with the search request and/or access notification from one or more external sources 350. For example, the entity computing system 310 may acquire information from various external sources such as one or more social media channels (e.g., social media networks, social media sites, social media messaging systems, location information, and the like), fitness trackers, Internet of Things (IoT) devices, and so forth. Additionally, or alternatively, the entity computing system 310 may retrieve results generated by various search systems. In some cases, the sourcing engine server 320 may retrieve information corresponding to the user and/or one or more members of the user's micro-community and/or another micro-community associated with actions and/or interests of a user, via the Internet 360 from the various social media channels and/or devices discussed above.

The networked computing system 300 may also include one or more networks, which may interconnect one or more of the entity computing system 310, the user devices 370, the secure network 362, one or more organization servers, and/or external sources 350. Thus, the entity computing system 310 may be in signal communication with the user devices 370 and/or one or more applications (e.g., an application 375) operating on one or more user devices 370, one or more other organization servers, and the external sources 150 via a network. The networks may include one or more of a wired network (e.g., the Internet 360, LAN, WAN, or the like), a wireless network (e.g., a cellular network, Bluetooth, NFC, or the like), or a combination of wired or wireless networks.

In some examples, the networked computing system 300 may include an organization network. The organization network may include one or more sub-networks (e.g., LANs, WANS, or the like). The organization network may be associated with a particular organization (e.g., a corporation, enterprise organization, educational institution, governmental institution, and the like) and may interconnect one or more computing devices associated with the organization. For example, the entity computing system 310 and organization servers (e.g., the sourcing engine server 320, the AI/ML engine 322, the rules engine server 324, the network permissions server 326, the user reward server 328, and the like) may be associated with an organization (e.g., an enterprise organization), and an organization network may be associated with and/or operated by the organization, and may include one or more networks (e.g., the Internet, LANs, WANs, VPNs, or the like) that interconnect the entity computing system 310, organization servers, and one or more other computing devices and/or computer systems that are used by, operated by, and/or otherwise associated with the organization. In some cases, the networked computing system 300 may include a secure network 362 operated by the organization to provide a secure communication link for one or more users (e.g., the user, micro-communities of users, customers, and the like) to safely and securely communicate from the one or more user devices 370, such as via the application 375, to one or more devices included in the entity computing system 310, such as by enabling user permissions, network permissions and/or passwords, one or more encryption method for the messages and communication packets communicated via the secure network 362. In some cases, the secure network 362 may be a stand-alone network operated by the entity. In some cases, the secure network may be a secure network capable of being logged into by a plurality of users via a different network connection. For example, a user may communicate from the user devices 370 to the entity computing system via a first network connection (e.g., the Internet 360, a cellular network, or other publicly accessible network) and may log into a second network connection (e.g., the secure network 362 or other such private network connection such as a virtual private network and the like.).

FIG. 3 shows an example implementation of an entity computing system 310 that may be used to generate, manage, or provide a secure network over which a user may solicit information and/or advice from a micro-community (or micro-communities) of users in relation to one or more interests or activities based on an identified user interest trigger. The user interest triggers may be identified by one or more components of the entity computing system 310 via information observed on a plurality of social media networks (e.g., the external sources 350 and the like) and/or electronic data records created by otherwise stored by one or more internal systems and/or databases (e.g., the data store 330 and the like). The entity computing system 310 may include various components, modules, and sub-modules that facilitate various tasks, including identifying one or more users of an entity's products and/or services, identifying one or more individuals that also use the entity's products and services, and/or external individuals known and/or trusted by the user, identifying one or more individuals that also use the entity's products and services that share a common interest or expertise based on sourcing information from one or more internal data stores, sourcing information from one or more external sources 350 (e.g., social media networks, and the like), analyzing the information based on rules defined by the entity, identifying one or more user interest triggers (e.g., an activity, a musical interest, a sporting event, an art supply purchase, a facility booking event, a facility payment event, a payment for providing an art object, a musical performance, a musical lesson activity, and the like), soliciting information corresponding to the interest event in response to the identification of the interest event trigger from one or more individual members of the micro-community associated with the user and/or identification of an activity of interest to the user that may be associated with another micro-community that may interest the user, assigning permissions to each member of the micro-community based on experiences, skills and/or other expertise corresponding to a topic of the micro-community, associating a rating to one or more of the user and each member of the micro-community who provided advice and/or granting rewards based on at least an amount of advice given and/or associated ratings. It will be appreciated that the entity computing system 310 illustrated in FIG. 3 is shown by way of example and that other implementations of an entity computing system 310 may include additional or alternative components, modules, sub-modules, and the like. In this example, the entity computing system 310 includes one or more processors 312, one or more memory devices 314, a communication interface 340, a user interface generator 316, an encryption engine 318, the sourcing engine server 320, the AI/ML engine 322, the rules engine server 324, the network permissions server 326, the user reward server 328, the data store 330, the user information database 332, the micro-community database 334, the expertise criteria database 336, and the like. Thus, the entity computing system 310 may be implemented using a special-purpose computing device (or computing devices) that have been specially programmed to perform functionality according to one or more aspects of the present disclosure.

The one or more processors 312 (e.g., a microprocessor, a microcontroller, and the like) of the entity computing system 310 may operate by using one or more algorithms that facilitates identifying individuals for inclusion in one or more micro-communities, analyzing a plurality of information obtained from a plurality of internal sources (e.g., the data store 330, and the like) and/or external sources 350 (e.g., social network posts, external venue activity postings, product or service advertisement or ticketing offerings (e.g., gallery opening, concert performances, and the like), identifying an expertise trigger associated with the user, configuring the micro-community or micro-communities of users including setting permissions and/or access rights to different information associated with the user and/or the entity, soliciting advice based on the permissions, expertise ratings, and the expertise trigger, assigning a rating to each user of the micro-community and/or providing rewards based on the ratings and/or participation in the trusted circle. These algorithms may be included as instructions or rules stored in the one or more memory devices 314, the data store 330, and/or may be included as a portion of the sourcing engine server 320, AI/ML engine 322, the rules engine server 324, the network permissions server 326, the user reward server 328 and the like. Additionally, the one or more processors 312 may operate by receiving information from the one or more external sources 350. An illustrative algorithm is described above with reference to FIG. 2.

In this example, the one or more processors 312 may be configured to operate the algorithm, the user interface generator 316, the encryption engine 318, provide or manage the secure network 362, and/or at least a portion of the sourcing engine server 320, the AI/ML engine 322, the rules engine server 324, the network permission server 326, the user reward server 328 and/or the data store 330, the user information database 332, the micro-community database 334 or the expertise criteria database 336 using an operating system (e.g., a proprietary operating system, an open source operating system, an embedded operating system, and/or the like). In some cases, the one or more memory devices 314 may be communicatively coupled to the one or more processors 312, such as via a data bus. The one or more memory devices 314 may be used to store any desired information, such as the aforementioned algorithms, a lookup table, computer-executable instructions to implement the sourcing of a trusted circle of individuals, identification of a life event trigger, providing ratings and/or permissions, and/or the like. The one or more memory devices 314 may be any suitable storage, including, but not limited to RAM, ROM, EPROM, flash memory, a hard drive, and so forth. In some examples, the one or more processors 312 may store information within and/or may retrieve information from the one or more memory devices 314.

The communication interface 340 of the entity computing system 310 may facilitate communication between one or more components of the entity computing system 310, the external sources 350, the user devices 370, and/or the organization servers via a network using one or more wired or wireless communication links. The communication interface 340 may facilitate communication between one or more networks internal to the entity computing system 310 or external to the entity computing system 310. In some cases, the communication interface 340 may be configured to communicate via an open network (e.g., the Internet 360) or a secured network (e.g., the secure network 362, a VPN), or a combination of public and private networks. In some examples, the entity computing system 310 may include one or more computing devices that may be communicatively coupled to a network. The network may be communicatively coupled to one or more devices, such as to servers associated with the external sources 350, the user devices 370, and/or the organization servers. The network may include one or more wired and/or wireless networks, such as a telecommunications network (e.g., a cellular network, a land line network, a cable network, and the like), a Wi-Fi network, a LAN, a WAN, the Internet 360, and the like. When used in a LAN networking environment, the entity computing system 310 may include a modem and/or other means for establishing wired and/or wireless communication over the WAN, such as the Internet 360. It will be appreciated that the network connections discussed herein are illustrative and other means of establishing communication links between one or more networks included as part of the entity computing system 310, the external sources 350, the user devices 370, and/or the organization servers 364 may include one or more various protocols such as TCP/IP, Ethernet, FTP, HTTP, and so forth.

The data store 330 of the entity computing system 310 may be used to store information related to a plurality of users (e.g., previous users and current users of the organization's products and/or services). For example, the data store 330 may include the user information database 332 for storing electronic data records associated with one or more users of the various products and/or services offered by the organization. In some cases, the user information database 332 may be used to store information related to user behavior associated with a user's activity while interacting with the organization's products and/or services. For example, the user information database may store information associated with one or more data records corresponding to electronic transactions. The user information may be scrubbed or otherwise edited to remove information not related to or relevant to forming micro-communities. In such cases, an electronic data record may include source information of an electronic transaction (e.g., to or from a music venue) and destination information (e.g., a user identifier), but other information such as an amount transferred may be redacted or otherwise filtered or removed. In some cases, the data store 330 may further include the micro-community database 334, a expertise criteria database 336, a rules repository and/or the like. The entity computing system 310 may utilize these databases to identify a plurality of users of the organization's products and services, identify links between different ones of the users (e.g., musical skills, musical interests, artistic skills or interests, athletic skills or interests, and the like), identify expertise events associated with one or more users (e.g., advising or consulting for art installations, teaching a course, professional or amateur credentials, and/or the like), configure a micro-community associated with each of a plurality of interests or skills associated with identified user skills or interests, set permissions associated with the users and members of one or more micro-communities, to collect historical and current user engagement data, to provide rewards and other incentives and the like.

As mentioned above, the user information database 332 may be used to store information associated with one or more users of the entity's products or services. As such, the user information database 332 may include user specific information and/or user interaction information, such as user interaction with the products, services, and/or departments of the entity. For example, the user information database 332 may include user names, user contact information (e.g., an address, a phone number, an email address, and the like) user demographics (e.g., a marital status, a parental status, a listing of associated family members, an educational status, artistic interests, sporting interests, musical interests, creative interests, and the like) and/or user interaction information such as one or more account numbers, a listing of subscribed products or services, financial information, insurance information, educational information, network login information, customer service contact records, and the like. In some cases, one or more data records may include a record ID, a title (e.g., text, graphics, audio, video, mixed media, and the like), a type, contents, one or more categories/subjects, one or more meta tags, a date created, an author, a length (e.g., a number of characters in the content, a file size, and the like), In some cases, the user information database 332 may include information that associates a user with one or more product and/or service categories, and may additionally maintain a hierarchical tree of the categories. As such, the user information database 332 may differentiate users based on one or more high-level categories (e.g., geographic location, business unit contact, product offerings, a level of proficiency with an activity or interest such as professional, amateur, hobbyist, learner, and the like) from low-level categories (e.g., e.g., an amount of account activity, financial records, transaction records, and the like). For instance, an example high-level category may be a geographic region (e.g., the Midwest, a state, a city, and the like) or a product category (e.g., a banking product offering, an insurance product offering, a product type such as a home improvement service, and the like), and an example low-level category may be a personal credit card, homeowner insurance, an architecture service, a home remodeling service, and the like. Further, the user information database 332 may associate one or more meta tags to particular user information, where the meta tags may be unique terms that correspond to a product or service provided by the entity. In some cases, some, or all of the meta tags associated with a user, product or service may be the same as some or all of the categories/subjects associated with an associated category. In examples where a user information record is assigned one or more meta tags, the entity computing system 310 may retrieve a set of search results from another database (e.g., the micro-community database 334, the expertise criteria database 336, the rules repository database, and the like) by matching particular user information records with the meta tags. As such, some or all of the user information records may be associated with meta tags that may be used to generate a set of results that may be used to generate trusted connections between different users such as to form micro-communities. It will be appreciated that one or more of these fields may be designated as mandatory or optional in some illustrative implementations of an entity computing system 310.

As mentioned above, the user information database 332 may store information related to a current user's or a previous user's interactions with the organization's products and/or services. The user information database 332 may be used to store information that has been gathered or tracked relating to interactions via various communication channels and devices, including in-person interactions, public network interactions, private network interactions and the like using the application 375 on mobile devices, tablets, smart phones, mobile phones, desktops, laptops, ATMs, wearable devices, and so forth. As such, the user information database 332 may store information relating to users accessing an organization's services via a mobile application, a mobile browser, a desktop application, a desktop browser, a wearable device application, and so forth. In some examples, the user information database 332 may store metrics associated with a user's interaction with some or all web pages associated with the organization. In other examples, the user information database 332 may store metrics associated with a user's interaction with some or all products and/or services provided by the organization. For instance, the user information database 332 may store a user ID, a username, browser(s) used to access organization's services, language(s) used to access organization's services, computing device(s) used to access organization's services (e.g., a smartphone, a laptop, a tablet, a wearable device, and so forth), screen resolution(s) used to access organization's services, location(s) (e.g., an address, a coordinate, or a generic description, such as coffee shop or home, and so forth) and/or IP address(es) from which organization's products or services were accessed, network speed(s), a number of times the user has accessed a particular page, a number of times the user accesses the same pages from different devices, the date(s) and time(s) at which the user accessed pages, the page(s) which the user has accessed, the referring page(s) (e.g., the pages the user was on before coming to the current page), average time spent on a page, average time spent engaged with an organization's representative in relation to products and services, minimum/average/maximum time spent on page(s), number of single-page visits, time elapsed since last interaction with the current page, and so forth. Additionally, in some cases, some or all user engagement metrics stored in the user information database 332 may be associated with one or more user interests or creative activities identified by the entity computing system 310 based on contextual data received from the external sources 350. Further, in some examples, the user information database 332 may maintain historical values of user engagement data (e.g., user engagement with contextualized set of results), such that the entity computing system 310 may utilize the historical information when identifying user connections and/or user interests and/or activities.

The user information database 332 may store information related to connections determined between users of the entity computing system and/or users of the organization's products and/or services as identified from a plurality of data sources. Examples of data that may be analyzed may include a user's current location, the user's demographic information, the user's educational information, the user's recreational and/or business interests, recent or upcoming creative, musical, artistic, and/or sporting events, user's relationship status, a user's history with the organization, user's employment history, and the like. The user information database 332 may store contextual data attributes according to the most recent update. For example, the user information database 332 may initially store a first user's current location. Following an update to the user's location, the user information database 332 may be updated to store a second user's current location. In other examples, the user information database 332 may maintain historical values of the contextual data attributes. For instance, following an update to the user's employment status, user information database 332 may be appending to include the most recent employment status, such that the user information database 332 maintains a history of the user's employment statuses. In some cases, the user information database 332 may include a user's relationship information corresponding to their immediate family members (e.g., parents, siblings, children, and the like), extended family (e.g., aunts, uncles, grandparents, cousins, step-siblings, step-parents, step-children and the like), and friends and acquaintances (e.g., personal friends, coworkers, employers, educators, advisors, and the like).

In some cases, the data store 330 may include one or more data repositories storing information corresponding to generation and maintenance of one or more micro-communities of individuals associated with each user (e.g., a micro-community database 334, and the like) and storing information corresponding to identification of one or more expertise or activity trigger, such as by using an expertise criteria database 336. In an illustrative example, one or more components of the entity computing system 310 (e.g., the sourcing engine server 320, the AI/ML engine 322, and/or the rules engine server 324 may process one or more algorithms to identify relationship between each of a plurality of users of the organizations products or services and/or interests, activities, and/or creative outlets utilized by each individual. In some cases, the sourcing engine server 320 may process instructions to implement an algorithm provided by the rules engine server 324 to monitor and/or analyze information presented to the public, or in more private, social media communications according to rules provided by the rules engine. Such communications may be analyzed by the sourcing engine to determine a relationship between users using products and services provided by the organization and/or with interests or other creative outlets. The sourcing engine server 320 may further analyze relationships found between users based on the information stored in the user information database 332 with or without use using the information obtained from the external sources 350. The micro-community database 334 may further include user preferences associated with the individuals identified as members of one or more micro-communities. For example, a user may input, via a user interface screen generated by the user interface generator 316 and/or the network permissions server 326, an access level for each member of their micro-community, such as by selectively allowing each individual access to their information and/or to allow a person to provide advice in response to expertise or activity triggers based on a level of identified expertise. For example, a user may include at least two individuals in a micro-community, where the user allows a first member such as a mentor (e.g., a teacher, an employer, an advisor, and the like) to have full access to their information and/or to provide input and/or advice regarding any expertise triggers. In some cases, the user may input a different, (e.g., lesser), access level to a second member (e.g., a parent, a sibling, a close friend or relative and the like) with lesser experience with a particular activity to allow lesser access to their information or to allow that particular member to provide advice to a specified subset of expertise triggers. For example, a user may select a setting that identifies that they have interest in performing a particular creative activity (e.g., painting, writing, musical performance, and the like), but may not allow the member to see any further detail about the creative activity. Similarly, the user may selectively allow a user to provide input to certain life events (e.g., a performance event, an art exhibition event, a photography session scheduling event, and the like). However, the user may selectively deselect particular life events from generating a notification to the same member of their micro-community (e.g., a parenting life event, a relationship event, and the like).

The expertise criteria database 336 may store thresholds and/or rules that may be used by the sourcing engine server 320, the AI/ML engine 322 in determining whether an expertise trigger condition has occurred. In some cases, the expertise criteria database may include information corresponding to a level of expertise corresponding to various creative activities (e.g., professional experience, amateur performance, financing or contracting experience, commercialization experience, event planning experience, skill in performing an activity, teaching skill or experience, and the like), an employment event (e.g., a job offer, a job acceptance, a termination event, a retirement event, and/or the like), and the like. In some cases, the expertise criteria database 336 may include information that may be used to identify an activity occurrence, such as a number of postings via one or more social media networks (e.g., the external sources 350) necessary to identify an activity event (e.g., one posting, two posting with the same account, one posting on each of two or more social media networks or accounts, and the like).

Additionally, in some cases, the data store 330 may be used to store computer-executable instructions to cause a computing device (e.g., the user interface generator 316, the encryption engine 318, the sourcing engine server 320, the AI/ML engine 322, the rules engine server 324, the network permissions server 326, and/or the user reward server 328) to facilitate identification of one or more individuals for inclusion in a micro-community or micro-communities, obtaining information from a plurality of external sources 350, analyzing the information received from the plurality of external sources, identifying an experience trigger, notification of one or more members of the micro-community in response to the expertise trigger, receiving information from the one or more members to the micro-community in response to the life event trigger, generating one or more user interface screens for presenting information to a user, communicating the one or more user interface screens to a user device 370, generating and/or presenting information concerning an earned reward in response to a response to an event, and the like.

In some cases, the micro-community database 334 may be used to store output from one or more matching algorithms employed by the rules engine server 324 and/or the sourcing engine server 320 and/or the AI/ML engine 322. Such algorithms may leverage stored customer information such as age, assets, geography, and activity experience milestones (e.g., learning, professional status, sponsorship or event planning experience, and the like) that may be retrieved from the user information database 332, as well as information obtained from one or more of the external sources 350 by the from the sourcing engine server 320 (e.g., social interests, and the like) to identify potential matches with other users of the products and services of the organization for the purpose of connecting via one or more micro-communities on the entity supported secure network 362 and any associated messaging platform. In some cases, the AI/ML engine 322 may perform a configuration process for each user, including social network profiles and/or login information for each social network. In some cases, a secure profile of micro-community members may be identified by the user or determined based on an analysis of social network activity. In some cases, friends and/or family may be suggested by the AI/ML engine 322 to be added and approved by the user via one or more user interface screens.

In some cases, one or more user preferences may be captured by the network permissions server 326, such as via a user interface screen generated by the user interface generator 316. For example, the network permissions server 326 may be used to request from one or more users a program opt-in status/date, consent status for each potential match as output from the AI/ML engine 322, and extent of the user profile information to share. For example, the permissions server 326 may receive a configuration input from a user, such as via a communicated user interface screen, to enable various permissions associated with each member of the micro-community. For example, the permissions may allow sharing information associated with a product subscription, may suppress an undesirable experience status, and/or may obscure values of particular assets. In some cases, the customer preferences stored in the micro-community database 334 may be modified in a channel-agnostic fashion and/or a device agnostic fashion, including a means of requesting network connection with specific customers via the secure network 362. In some cases, a permissions hierarchy may be defined to allow user to configure which individuals or other members of the micro-community are to be allowed to offer advice. The user can selectively approve and/or block members from all events or selected event triggers. In some cases, a grading interface may be used to allow advice to be graded and used to assign a rating to each member of the micro-community based on self-reported scores and/or scores from others.

In some cases, the user reward server 328 may be used to store in data repository of advice ratings, such as the micro-community database 334. The rewards server may present a rating user interface screen to a user via the secure network 362 for display on a display of the one or more user devices 370. The ratings may be a numerical rating, a letter rating, a textual rating, or a visual rating (e.g., a 3-5 star scale or the like) and may be used to inform future rules engine assessment values, periodic reassessment values for matched members of the micro-community and/or the users associated with each micro-community, and/or recommendation criteria for subsequent and ongoing match considerations.

In some cases, communication between the sourcing engine server 320 and/or the social media networks comprising the external sources 350 may be analyzed to detect one or more event triggers that may cause solicitation (e.g., a pull request, a push request) of advice for the user from the one or more members of the micro-community. The sourcing engine server 320 may store a database of information corresponding to a plurality of users including, for example, prior expertise events, ratings and/or scores associated with each event or activity, and/or the like. The AI/ML engine 322 may be used to link users together based on the event triggers, activities, interests, personal connections, professional connections, and/or the like.

In some cases, the secure network 362 may be used by a plurality of users for secure communication, such as by using encoded data communicated over a private network. The encoded messages may be communicated via the secure network 362 and may be encrypted by the encryption engine 318 of the entity computing system 310 using one or more encryption algorithms, such as an asymmetric encryption algorithm, a block cipher, an encryption key, a symmetric encryption algorithm, and/or the like.

In some cases, the entity computing system, for each identified event trigger, may provide information to one or more users, such as via a user interface screen on a mobile device or other remote interface associated with the user, such as the user devices 370. The user interface screen may be generated by the user interface generator and be communicated to the user device 370 via one or more network connections, such as the Internet and/or the secure network 362. The user interface screens may be used by the user to identify which members of the micro-community can be solicited for advice, such as by reviewing presented ratings (e.g., grades) information. In some cases, based on permissions associated with the users, some members of the micro-community may be notified when one or more event triggers have been identified and then these trusted members of the micro-community may be allowed to give advice and/or may ask the user whether they desire advice. In some cases, access may be granted to the secure network 362 based on user approval. The user may be presented a user interface screen (e.g., a graphical user interface screen and the like) that may be used to enter information concerning users which are to be added as members of the micro-community that may provide advice. In such systems, user interactions with the business entity computing system may be minimized and may simplify user interactions with the entity computing system (e.g., financial transactions). In some cases, the systems and methods discussed herein may be used on a “pay it forward” concept where users of social media content may be assisted in addressing one or more event triggers. The users may be able to rate themselves on how certain events have been handled or performed and in which advice can be offered to others in their micro-community.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media a storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a plurality of application computing systems, each application computing system comprising a data repository storing electronic data records corresponding to electronic transactions for a plurality of users;
a computing platform, comprising:
at least one processor; and
memory storing computer-readable instructions that, when executed by the at least one processor, cause the computing platform to:
train an artificial intelligence/machine learning (AI/ML) model based on a plurality of electronic data records retrieved from the plurality of application computing systems;
generate, by a trained AI/ML model, a plurality of micro-communities of users associated with activities identified from the plurality of electronic data records;
facilitate, via a user application, electronic communication within the plurality micro-communities and between a plurality of user devices associated with members of the micro-communities;
retrain, based on analysis of micro-community communications, the AI/ML model.

2. The system of claim 1, wherein the instructions cause the computing platform to aggregate historical electronic data records from each of the plurality of application computing system.

3. The system of claim 1, wherein the instructions cause the computing platform to anonymize each electronic data record from the plurality electronic data records aggregated from each of the plurality of application computing system by removing financial and/or personal information from the data record.

4. The system of claim 1, wherein each micro-community corresponds to an identified creative interest.

5. The system of claim 1, wherein a first micro-community comprises a same experience level for each of the members.

5. The system of claim 1, wherein each micro-community comprises a different experience levels for each member of the micro-community.

6. The system of claim 1, herein the instructions cause the computing platform to:
determine, based on monitored first micro-community activities, a participation level for each member of the first micro-community; and
communicate, an electronic reward communication to at least one member of the first micro-community based on the participation level for each member of the first micro-community.

7. The system of claim 1, wherein the instructions cause the computing platform to:
receive, via an application on a user device, feedback concerning the micro-community; and
retrain, based on the feedback, the AI/ML model.

8. A method comprising:
training an artificial intelligence/machine learning (AI/ML) model based on a plurality of electronic data records retrieved from a plurality of application computing systems;
generating, by a trained AI/ML model, one or more micro-communities of users associated with activities identified from the plurality of electronic data records;
facilitating, via a user application, electronic communication within the one or more micro-communities and between a plurality of user devices associated with members of the micro-communities;
retraining, based on analysis of micro-community communications, the AI/ML model.

9. The method of claim 8, further comprising aggregating historical electronic data records from each of the plurality of application computing system.

10. The method of claim 8, further comprising anonymizing each electronic data record from the plurality electronic data records aggregated from each of the plurality of application computing system by removing financial and/or personal information from the data record.

11. The method of claim 8, wherein each micro-community corresponds to an identified creative interest.

12. The method of claim 8, wherein a first micro-community comprises a same experience level for each of the members.

13. The method of claim 8, wherein each micro-community comprises a different experience levels for each member of the micro-community.

14. The method of claim 8, further comprising:
determining, based on monitored first micro-community activities, a participation level for each member of the first micro-community; and
communicating, an electronic reward communication to at least one member of the first micro-community based on the participation level for each member of the first micro-community.

15. The method of claim 8, further comprising:
receiving, via an application on a user device, feedback concerning the micro-community; and
retraining, based on the feedback, the AI/ML model.

16. Non-transitory computer readable media storing instructions that, when executed by a processor, cause a computing platform to:
train an artificial intelligence/machine learning (AI/ML) model based on a plurality of electronic data records retrieved from a plurality of application computing systems;
generate, by a trained AI/ML model, one or more micro-communities of users associated with activities identified from the plurality of electronic data records;
facilitate, via a user application, electronic communication within the one or more micro-communities and between a plurality of user devices associated with members of the micro-communities;
retrain, based on analysis of micro-community communications, the AI/ML model.

17. The non-transitory computer readable media of claim 16, wherein the instructions cause the computing platform to aggregate historical electronic data records from each of the plurality of application computing systems.

18. The non-transitory computer readable media of claim 16, wherein the instructions cause the computing platform to anonymize each electronic data record from the plurality electronic data records aggregated from each of the plurality of application computing system by removing financial and/or personal information from the data record.

19. The non-transitory computer readable media of claim 16, wherein the instructions cause the computing platform to:
receive, via an application on a user device, feedback concerning the micro-community; and
retrain, based on the feedback, the AI/ML model.

20. The non-transitory computer readable media of claim 16, wherein each micro-community comprises a different experience levels for each member of the micro-community.
